(19) United States
(12) Patent Application Publication
(10) Pub. No.: US 2016/0016186 A1
(43) Pub. Date: Jan. 21, 2016

(54) SYSTEM AND METHOD FOR DETERMINING COMPONENT-RELATED DELAY TIMES FOR THE ROBOT-BASED SPRAY APPLICATION OF VISCOUS FLUIDS

(71) Applicant: ABB Technology AG, Zurich (CH)

(72) Inventors: Jens HOFSCHULTE, Friedrichsdorf (DE); Christian SEVEKE, Dresden (DE); Frank HENTSCHEL, Schmalkalden (DE)

(73) Assignee: ABB TECHNOLOGY AG, Zurich (CH)

(21) Appl. No.: 14/755,208

(22) Filed: Jun. 30, 2015

(30) Foreign Application Priority Data
Jun. 30, 2014 (EP) 14 002 233.6

(51) Int. Cl. B05B 1/30; B25J 9/16

(52) U.S. Cl. CPC B05B 1/30; B25J 9/1679; Y10S 901/43

(57) ABSTRACT

A system and method are disclosed for determining component-related delay times for the spray application of viscous fluids, which includes an actuable application system for a viscous fluid having at least components of a metering device, fluid valve and application nozzle. The dynamic behaviour of the application system can be dependent, with respect to the volume flow profile of the viscous fluid during the application and component-related delay times, and an impacted object to be sprayed with the viscous fluid by the application nozzle. The system can include a vibration sensor for continuously sensing vibrations of the impacted object, and at least one computing device which is provided for actuating the application system with a sequence of predefinable input parameters, for bringing about a chronological correlation between the change in an input parameter and a change occurring thereafter in the vibration profile and determining therefrom, a respective component-related delay time.

### RELATED APPLICATION(S)

This application claims priority to European Application 14 002 233.6 filed in Europe on Jun. 30, 2014. The entire content of which is hereby incorporated by reference in its entirety.

1. Field

The disclosure relates to a system for determining component-related delay times for the spray application of viscous fluids, including an actuable application system for a viscous fluid having at least a metering device, a fluid valve and an application nozzle, wherein the dynamic behaviour of the application system can be dependent, with respect to the volume flow profile of the viscous fluid during the application, also on, for example, component-related delay times, and an impacted object to be sprayed with the viscous fluid by the application nozzle.

2. Background Information

In many fields of industrial production, a spray application of viscous or highly viscous fluids can be used, for example, in the car industry when applying sound absorption mats or for seam sealing. The application of adhesives can also be a field of use for spray applications.

A corresponding application system can include a metering device, a hose connection, an application nozzle, and a fluid valve situated close to the application nozzle in terms of fluid mechanics. With the fluid valve, the fluid duct, which can be formed between the metering device and the application nozzle by the specified components, can be selectively interrupted in order, for example, to prevent the fluid from dripping from the application nozzle when the metering device can be switched off. The coordination of the switching on and off of the metering device and fluid valve, in order, for example, to avoid a situation in which the metering device can be switched on while the fluid valve is still closed, can bring about a rise in pressure.

Due to the high viscosity of the material to be applied, the application of the material occurs under pressure, for example, by using a metering cylinder with a servo drive. However, those skilled in the art can be familiar with exemplary embodiments of metering devices such as geared pumps or spiral pumps. The hose connection between the metering cylinder and the application nozzle can be configured as a high-pressure hose. An application system therefore can include a dynamic behaviour, which can be dependent, for example, on the elasticity of the hose, the rotary masses of the drive of the metering device and delay times, for example, during the switching on or off of the metering device or the switching on or off of the fluid valve. However, the type of viscous fluid to be applied as such can also include an influence on the dynamic behaviour of an application system.

The final geometric shape of the viscous material which is applied to the surface of an object under high pressure by an application nozzle can be dependent on the width and homogeneity of the spray jet, the speed at which the application nozzle is moved over the surface of the object to be applied, for example, a robot, and the respective volume flow through the application nozzle. Due to a linear movement of the application nozzle, the viscous material can be applied in a strip-like shape to the surface of an object.

A layer thickness, which can be homogenous, and a constant width of the applied material strip can be desired, the width of the strip can be dependent on the volume flow of the fluid through the fluid duct of the application system during the application process. However, after a change in the input parameters of the application system, due to the high dynamics, already mentioned, of such an application system, the volume flow itself can be subject to certain dynamic fluctuations, and which can bring about a deviation, in certain areas, of the actually applied strip width from the desired strip width.

The dynamic behaviour of an application system can also be determined by component-related delay times, for example, the delay times during the switching on or off of the components of the metering device and the fluid valve. If the metering device is activated temporally before the opening of the fluid valve, pressure can build up in the application duct within a very short time, and the pressure can endanger the application system as such, which can, also give rise, at the subsequent opening of the fluid valve, to an initially significantly increased volume flow because a reduction in pressure then firstly takes place in the fluid duct.

If the fluid valve is not closed until after the switching off of the metering device, the volume flow is not abruptly interrupted but instead a subsequent outflow of viscous fluid through the application nozzle can occur because the previously built-up pressure of the viscous fluid located in the fluid duct can be reduced.

The real switching times, for example, of the metering device and fluid valve, therefore have to be adjusted to one another in order to achieve an optimum application result. Given knowledge of the respective delay times, the issuing of an input signal can be brought forward by the respective delay time, with the result that a change can be ultimately effective at a desired switching time and targeted adjustment of the real switching times.

According to the known art, the application nozzle can be moved linearly at a constant speed over a plate during a test application in order to determine a delay time. When a specific path position is reached, a signal for switching on or off a respective application component can be issued, wherein a change in the application result can occur only with a chronological offset. The chronological offset can result in a local offset in the profile of the application result due to the movement of the application nozzle. Given knowledge of the movement speed of the application nozzle, a respective delay time can therefore be determined on the basis of a measured local offset between the position of the nozzle when the input parameter changes and the occurrence of the change in the application result.

The determination of delay times can occur indirectly on the basis of a length measurement of an applied fluid strip on an impacted object, and can be very costly, and due to manual intermediate steps, the determination of delay times cannot be automated, or can only be automated in a very costly fashion.

### SUMMARY

A system is disclosed for determining component-related delay times for spray application of viscous fluids, comprising: an actuable application system for a viscous fluid having at least components of a metering device, a fluid valve and an application nozzle for spraying an impacted object, and wherein a dynamic behaviour of the application system is dependent, with respect to a volume flow profile of the viscous fluid during the application and component-related delay times; a vibration sensor for continuously sensing vibrations of an impacted object during the application of the viscous fluid, and wherein the vibration sensor is configured to provide continuous measurement data for generating a vibration profile; and at least one computing device which is configured to actuate the application system with a sequence of predefinable input parameters for bringing about a chronological correlation between a change in an input parameter of the application system and a change occurring thereafter in the vibration profile and determining therefrom and making available, a respective component-related delay time.

A method is disclosed for determining and applying component-related delay times for the spray application of viscous fluids with an actuable application system for a viscous fluid having at least components of a metering device, a fluid valve and an application nozzle, an impacted object to be sprayed with the viscous fluid by the application nozzle, a vibration sensor for continuously sensing vibrations of the impacted object during the application of the viscous fluid, and wherein the vibration sensor is configured to provide continuous measurement data for generating a vibration profile, and at least one computing device which is configured to actuate the application system with a sequence of predefinable input parameters for bringing about a chronological correlation between a change in an input parameter of the application system and a change occurring thereafter in the vibration profile and determining therefrom and making available, a respective component-related delay time, the method comprising: applying the viscous fluid to the impacted object; actuating the application system according to the sequence of predefined input parameters; generating a corresponding vibration profile from a continuous determination of vibrations of the impacted object; determining at least one delay time between at least one change in an input parameter and an occurrence of at least one subsequent change in the vibration profile; and assigning the delay time to the respective component whose input parameter has been changed previously.

### BRIEF DESCRIPTION OF THE DRAWINGS

The disclosure is explained below with reference to the exemplary embodiments shown in the drawings. In the drawings:

FIG. 1 shows an exemplary system for determining component-related delay times; and

FIG. 2 shows an exemplary vibration profile during a change in an input parameter.

### DETAILED DESCRIPTION

In accordance with an exemplary embodiment, a system is disclosed with which component-related delay times of an application system can be determined relatively easily.

In accordance with an exemplary embodiment, a system is disclosed, which can include a vibration sensor for continuously sensing vibrations of the impacted object, for example, during the application of the viscous fluid, wherein the vibration sensor is provided to make available a vibration profile in the form of continuous measurement data, and at least one computing device which is provided for actuating the application system with a sequence of predefinable input parameters, for bringing about a chronological correlation between the change in an input parameter of the application system and a change occurring thereafter in the vibration profile and determining therefrom and making available a respective component-related delay time.

In accordance with an exemplary embodiment, the concept of the disclosure is to carry out, during the application, a vibration measurement at the impacted object, which vibration measurement, a beginning or ending or an increased or reduced impact of applied viscous fluid is detected. A vibration can be conditioned by shocks, which can both occur once and be slight, wherein periodic shocks can also occur. Both the beginning and the end of an application of viscous fluid can cause a change in the vibration profile as a result of the impact pulse, wherein the vibration profile can be used as an indicator of the detection of the point when a change in the input parameters of the application system becomes effective.

In accordance with an exemplary embodiment, a chronological correlation of the vibration profile with the changing of the input parameters can be sensed. This can be achieved, for example, in that at least some of the measurement data items of the vibration profile can be provided with a timestamp, as a result of which the determination of the chronological interval between the respective measurement data items with respect to time of the change in the input parameters can be made.

Additionally storing the chronological information can provide for subsequent analyse the measurement data of the vibration profile, which can be advantageous because the detection of the time of a change in the vibration profile uses, under certain circumstances, the repeated analysis thereof, which cannot take place in real time.

In order to effectively detect the time of a change in the vibration profile it can be appropriate to change the input parameters during the application, for example, in such a way that, as a result thereof, changes occur in the volume flow of the applied fluid which are as unambiguous and which themselves bring about a change which is as unambiguous in the vibration profile at the impacted object.

In accordance with an exemplary embodiment, this can be implemented, for example, in the case of the determination of the delay time of the opening of the fluid valve, in that an admission pressure is previously built up in the closed fluid duct by means of a time profile of the metering device, with the result that immediately after the opening of the fluid valve as a consequence of a reduction in pressure an increased volume flow flows through the application nozzle, which volume flow can bring about, for example, an unambiguous change in the vibration profile. Before the opening of the fluid valve, there can be at least theoretically no vibration present, whereas with the first impact of the viscous fluid on the surface of the impacted object a significant vibration occurs. In a similar way, the delay time can also be determined during the closing of the fluid valve.

During the determination of the delay times for the metering device, the change in the vibration profile can be influenced to a degree also by the dynamic behaviour of the application system, for example, of the hose connection between the metering device and the application nozzle. A change in the input parameters of the application system can give rise to a dynamic equalization process in the profile of the volume flow and therefore can also be in the vibration profile.

In accordance with an exemplary embodiment, a suitable way of determining the time of the occurrence of a change in the vibration profile therefore can include estimating the vibration profile in advance by means of intervals on the basis of previous measurement data for a time interval and using a deviation of the measured value from the estimated value as a criterion for the occurrence of a change in the vibration profile.

In addition, stochastic fluctuations can be eliminated in the vibration profile using a digital filter, and to determine in parallel the time of occurrence of a change in the vibration profile by means of a plurality of different detection algorithms and to determine the delay time on the basis of the most plausible results.

The computing device can be, for example, a personal computer. The tasks to be performed by the computing device can be transferred to a robot controller which can also be considered to be a computing device and which is provided for controlling an industrial robot on which, for example, the application nozzle of the application system is mounted, which provides both the advantage of eliminating an additional computing device and the advantage that a chronological correlation between the change in the input parameters, the movement of the robot and the vibration profile can be determined relatively easily because all the necessary data can be available simultaneously in the same computing device.

In accordance with an exemplary embodiment, a rigid plate can serve, for example, as an impacted object. In addition, an impacted object can be equipped with a complex shape, such as a car body or the like, with a corresponding vibration sensor. In this way, a vibration measurement on an object to be sprayed can itself be carried out in a relatively easy way, with the result that, for example, when a viscous fluid with different properties is used, adapted delay times can be determined during a pause in a production system. An additional measurement setup is not used, apart from an impacted object, a vibration transmitter and the data-transmitting connection thereof to a computing device or a robot controller.

This easily permits component-related delay times of an application system to be determined.

According to an exemplary embodiment of the system, the vibration sensor can be provided for making available measurement data with a sampling frequency of, for example, 100 Hz or higher. For example, the higher the sampling frequency, the more precisely a delay time can be determined. A frequency of, for example, 100 Hz can correspond to a sampling interval of, for example, 10 ms, which can constitute the lower limit for a practical determination of the delay time, wherein higher sampling frequencies of, for example, 1 kHz and higher, can permit further increased accuracy. Delay times can be, for example, in the region of 50 ms to 200 ms.

In accordance with an exemplary embodiment, the metering device and/or the fluid valve can be actuated by one of the input parameters. Both components can be subject to delay times, which can easily be determined by the system according to the disclosure. According to a further disclosure variant, the impacted object can be fabricated from a lightweight, rigid material, as a result of which vibrations occurring as a result of the impact of viscous fluid can be transmitted to a vibration sensor arranged on the impacted object.

In accordance with an exemplary embodiment, at least the application nozzle of the application system can be arranged on an industrial robot. The use of an industrial robot can permit a movement of the application nozzle relative to the impacted object to be controlled in a monitored fashion, wherein at least some of the working steps which are to be carried out by the computing device can be provided to be carried out by an associated robot controller of the industrial robot.

In accordance with an exemplary embodiment, a method is disclosed for determining and applying component-related delay times for the spray application of viscous fluids with a system according to the disclosure, including the following steps, actuating the application system according to a sequence of predefined input parameters, wherein a viscous fluid is applied to the impacted object, continuous determination of vibrations of the impacted object while a corresponding vibration profile is applied and made available, determining at least one delay time between at least one change in an input parameter and the occurrence of at least one subsequent change in the vibration profile, assigning the delay time to the respective component whose input parameter has been changed previously, optionally transmitting the determined component-related delay time into this, or into a structurally identical, an actuable application system.

According to an exemplary embodiment of the method according to the disclosure, in addition to a vibration profile, the profile of at least one further fluid-related measurement variable, for example, the pressure profile of the fluid in the interior of the application system, can also be determined and made available, and the at least one delay time between a change in an input parameter and the occurrence of a subsequent change in the profile of the further fluid-related measurement variable can be determined.

In accordance with an exemplary embodiment, making available a pressure sensor can permit the pressure in the interior of the application system or in the fluid duct thereof to be determined. The chronological interplay between the metering device and the fluid valve decisively can determine the pressure profile in the fluid duct. The pressure profile can therefore also be a suitable variable for determining component-related delay times of the application system, for example, of the components of the fluid valve and the metering device. An improved overall result can advantageously be determined in a subsequent evaluation step from the respectively previously determined delay times by means of the various determination methods of a respective delay time by means of a vibration profile and profile of a further fluid-related measurement variable such as the pressure in the fluid duct.

In accordance with an exemplary embodiment, before a respective delay time is determined precisely one input parameter is changed by means of the sequence, and the sequence therefore includes only the changeover of precisely one parameter from a first value to a second value. In this way, an effect, for example, the change in the vibration profile, can be, for example, easily assigned to a cause, for example, the change in the precisely one input parameter.

In accordance with an exemplary embodiment, the metering device and/or the fluid valve are/is switched on or off by means of one of the input parameters. Both components can be subject to delay times, for example, in the range from 50 ms to 200 ms, which can be determined by the system.

In accordance with an exemplary embodiment, in each case different delay times can be assigned to a respective component, for example, the fluid valve or the metering device, for the switching on and switching off. The opening behaviour of a fluid valve can be, for example, different from its closing behaviour because the opening process and closing process occur, under certain circumstances, by means of various actuators. In order to determine a delay time for the opening of a fluid valve, the latter is to be transferred from the closed state into the open state by means of a change in the input parameters thereof, and in order to determine the delay time for the closing it is to be transferred from the open state into the closed state, wherein the time period of the change in the input signal up to the occurrence of a change in the profile represents the respective delay time.

In accordance with an exemplary embodiment, the method can be repeated for a plurality of input parameters. As a result, a plurality of delay times for one and/or more components can correspondingly be determined.

In accordance with an exemplary embodiment, this, or a structurally identical, an actuable application system can apply a viscous fluid using the determined component-related delay times, wherein a respective input parameter of a respective component can be changed predictively by shifting chronologically by the respective delay time before a desired respective change time. As a result, during use of the application system in production, component-related delay times can be compensated and targeted chronological adjustment of components, such as, for example, the metering device and the fluid valve can be simplified.

In accordance with an exemplary embodiment, a structurally identical, an actuable application system can be arranged in a fixed fashion and an object which is to be sprayed can be moved by a robot relative to the application nozzle during the application process. The fixed arrangement of the application system with its application nozzle can prevent negative influences of a movement of the application system on its dynamic behaviour.

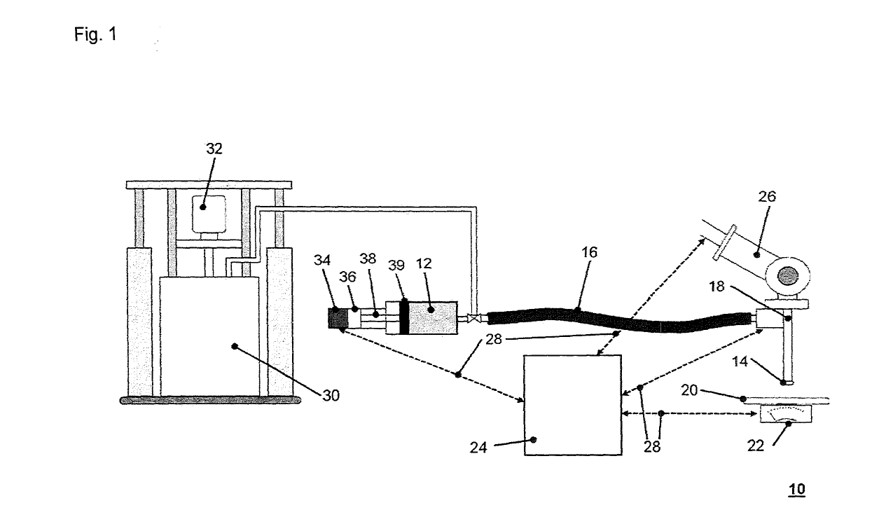

FIG. 1 shows an exemplary system for determining component-related delay times in a schematic illustration 10. A metering device 12, including a metering drive 34, a gear mechanism 36, a spindle 38 and a metering cylinder 39, can be provided for forcing a viscous fluid with a predefined volume flow from the metering cylinder 39. The volume flow ultimately can result from the rotational speed of the metering drive 34, wherein a specific volume can be assigned to each rotation on the basis of the peripheral geometric conditions. A predefinition of a desired volume flow can be made in this case by means of the input parameter of the rotational speed of the metering drive.

The viscous fluid which flows out of an outlet opening of the metering cylinder 39 can be fed to an application nozzle 14 via a high-pressure hose 16, wherein a fluid valve 18 is provided just upstream of the application nozzle 14 in terms of fluid mechanics, by means of which fluid valve 18 the fluid duct which can be formed by the components mentioned above can be shut off. The application nozzle 14 can be arranged at the distal end of the arm of an industrial robot 26, which can have, for example, 6 degrees of freedom of movement and an arm length of 2.5 m. As a result, controlled movement of the application nozzle 14 along the surface of an object to be sprayed, wherein a spraying distance of, for example, 10 mm to 20 mm can be maintained.

In this example the viscous fluid can be applied to an impacted object 20, in this case a lightweight, rigid plate which can be arranged horizontally underneath the application nozzle 14. The impacted object 20 can be arranged on a vibration sensor 22, and which can be provided for continuously transmitting vibrations of the impacted object 20 by means of a communication line 28 to a computing device 24. The computing device 24 can be, for example, a robot controller, which can be provided for controlling the industrial robot 26 and the metering device 12.

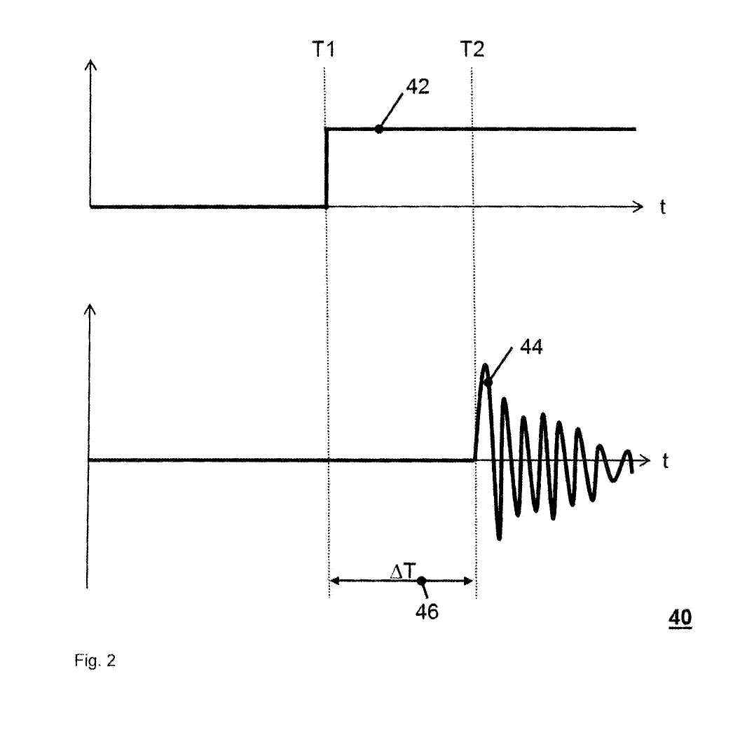

FIG. 2 shows an exemplary vibration profile during a change in an input parameter in an illustration 40. The input parameter for the switching signal of a fluid valve is changed at a time T1, as is apparent from the input parameter profile 42, with the result that the latter can be opened and subsequently viscous fluid can be applied. Up to the time T2, the chronologically correlated vibration profile 44 does not exhibit deflections because there is no application of viscous fluid, which could cause vibrations. Due to a component-related delay time of the fluid valve, the fluid duct can only be released after a delay at the time T2, with the result that a vibration does not occur until from this time. A delay time 46 can result from the difference between the times T1 and T2.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMBERS

10 Exemplary system for determining component-related delay times
12 Metering device
14 Application nozzle
16 High-pressure hose
18 Fluid valve
20 Impacted object
22 Vibration sensor
24 Exemplary computing device
26 Industrial robot
28 Communication line
30 Fluid reservoir
32 Drive unit
34 Metering drive
36 Gear mechanism
38 Spindle
39 Metering cylinder
40 Exemplary vibration profile given a changed input parameter
42 Input parameter profile
44 Vibration profile
46 Delay time

What is claimed is:

1. A system for determining component-related delay times for spray application of viscous fluids, comprising:
an actuable application system for a viscous fluid having at least components of a metering device, a fluid valve and an application nozzle for spraying an impacted object, and wherein a dynamic behaviour of the application system is dependent, with respect to a volume flow profile of the viscous fluid during the application and component-related delay times;
a vibration sensor for continuously sensing vibrations of an impacted object during the application of the viscous fluid, and wherein the vibration sensor is configured to provide continuous measurement data for generating a vibration profile; and
at least one computing device which is configured to actuate the application system with a sequence of predefinable input parameters for bringing about a chronological correlation between a change in an input parameter of the application system and a change occurring thereafter in the vibration profile and determining therefrom and making available, a respective component-related delay time.

2. The system according to claim 1, wherein the vibration sensor is configured to provide measurement data with a frequency of 100 Hz or higher.

3. The system according to claim 1, wherein the metering device is actuated by one of the predefinable input parameters.

4. The system according to claim 1, wherein the fluid valve is actuated by one of the predefinable input parameters.

5. The system according to claim 1, in combination with an impacted object, wherein the impacted object is fabricated from a lightweight, rigid material, and as a result of which vibrations occurring as a result of the impact of viscous fluid can be transmitted to the vibration sensor when arranged on the impacted object.

6. The system according to claim 1, wherein at least the application nozzle of the application system is arranged on an industrial robot.

7. A method for determining and applying component-related delay times for the spray application of viscous fluids with an actuable application system for a viscous fluid having at least components of a metering device, a fluid valve and an application nozzle, an impacted object to be sprayed with the viscous fluid by the application nozzle, a vibration sensor for continuously sensing vibrations of the impacted object during the application of the viscous fluid, and wherein the vibration sensor is configured to provide continuous measurement data for generating a vibration profile, and at least one computing device which is configured to actuate the application system with a sequence of predefinable input parameters for bringing about a chronological correlation between a change in an input parameter of the application system and a change occurring thereafter in the vibration profile and determining therefrom and making available, a respective component-related delay time, the method comprising:
applying the viscous fluid to the impacted object;
actuating the application system according to the sequence of predefined input parameters;
generating a corresponding vibration profile from a continuous determination of vibrations of the impacted object;
determining at least one delay time between at least one change in an input parameter and an occurrence of at least one subsequent change in the vibration profile; and
assigning the delay time to the respective component whose input parameter has been changed previously.

8. The method according to claim 7, comprising:
transmitting the determined component-related delay time into the actuable application system.

9. The method according to claim 7, comprising:
transmitting the determined component-related delay time into a structurally identical actuable application system.

10. The method according to claim 7, comprising:
determining in addition to the vibration profile, a profile of at least one further fluid-related measurement variable.

11. The method according to claim 10, wherein the at least one further fluid-related measurement variable comprises:
a pressure profile of the fluid in an interior of the application system.

12. The method according to claim 10, comprising:
determining the at least one delay time between a change in an input parameter and an occurrence of a subsequent change in the profile of the at least one further fluid-related measurement variable.

13. The method according to claim 7, wherein before a respective delay time is determined, changing precisely one input parameter of the sequence of predefined input parameters.

14. The method according to claim 7, comprising:
switching the metering device on or off based on an input parameter.

15. The method according to claim 7, comprising:
switching the fluid valve on or off based on an input parameter.

16. The method according to claim 7, comprising:
assigning in each case different delay times to a respective component for the switching on and switching off.

17. The method according to claim 7, comprising:
repeating the method for a plurality of input parameters.

18. The method according to claim 7, comprising:
applying the viscous fluid using the determined component-related delay times; and
changing a respective input parameter of a respective component predictively by shifting chronologically by the respective delay time before a desired respective change time.

19. The method according to claim 18, comprising
arranging in a fixed fashion and moving an object which is to be sprayed by a robot relative to the application nozzle during the application process.
